(19) United States
(12) Patent Application Publication
(10) Pub. No.: US 2023/0045898 A1
(43) Pub. Date: Feb. 16, 2023

(54) RADIAL PISTON HYDRAULIC MOTOR COMPRISING HOLLOW ROTATING SHAFT INSIDE THE MOTOR

(71) Applicant: BLACK BRUIN OY, Jyskä (FI)

(72) Inventors: Laurent Eugène ALBERT, Reims (FR); Tero YLÄ-MONONEN, Jyväskylä (FI)

(73) Assignee: BLACK BRUIN OY, Jyskä (FI)

(21) Appl. No.: 17/887,004

(22) Filed: Aug. 12, 2022

(30) Foreign Application Priority Data
Aug. 12, 2021 (FI) 20215849

(51) Int. Cl. F03C 1/28; F03C 1/30; F03C 1/38

(52) U.S. Cl. CPC F03C 1/0406; F03C 1/0409; F03C 1/0444

(57) ABSTRACT

A radial piston hydraulic motor comprising a hollow rotating shaft inside the motor, which rotating shaft is arranged to rotate around its axial central axis A for providing torque from the radial piston hydraulic motor, wherein the rotating shaft comprises a piston frame with pistons, which are arranged to move radially, the piston frame comprises a distribution surface, which is a flat surface in parallel plane with the radial movement of the pistons, and a first inner surface extending in axial direction around the axial central axis A, wherein the rotating shaft comprises a half shaft having a second inner surface extending in axial direction around the axial central axis A, wherein piston frame and the half shaft are arranged adjacent to each other so that the first inner surface and the second inner surface form a surface, in axial direction, forming a cavity inside the rotating shaft for receiving a drive shaft.

### TECHNICAL FIELD

The present invention relates to radial piston hydraulic motors.

### BACKGROUND OF THE ART

A hydraulic motor is a mechanical actuator that converts hydraulic pressure and flow into torque and angular displacements, i.e. rotation. In radial piston hydraulic motors, the pistons are arranged radially inside a piston frame and they are reciprocating in radial direction. The outer end of each piston has a piston roller which are pushed against a cam ring with multiple lobes. By the pressure of hydraulic fluid, the pistons are pushed outwards against the lobes of the cam ring, which causes the piston frame to rotate.

In known solutions, the piston frame also forms the shaft of the motor, i.e. it is uniform part rotating inside the motor. Therefore, the piston frame extends through the motor from rear to front in axial direction and forms a cavity inside the motor for receiving a drive shaft to which the rotational movement is transferred.

The hydraulic fluid is distributed to the piston via distribution channels, which are provided in non-rotating part, e.g. a frame, of the motor. Typically, the distribution channels are located at the rear part of the motor. The distribution channels are connected to supply holes in the piston frame and the hydraulic fluid is provided under the pistons through said supply holes. The size, i.e. the diameter, of the supply holes determines the possible speed of the motor. The hydraulic fluid is provided in axial direction and, therefore, the pressure of the hydraulic fluid causes axial force, which strives to form a gap between the frame and the piston frame. To avoid this, a counter axial force must be created. In known motors, the counter force is created by providing bearings at both ends of the motor, i.e. front end and rear end, in the form of tapered roller bearings. The bearings are provided between the shaft part of the piston frame and the frame of the motor. The tapered roller bearings are tapered from the ends of the motor towards the center of the motor and, thus, they form mechanical stop, i.e. form the counter force for the axial force caused by the pressure of the hydraulic fluid. However, such arranged tapered roller bearing transfers the force to the shaft part of the piston frame and the shaft must have very rigid structure, i.e. the shaft needs a big wall thickness and/or greater diameter.

Radial piston hydraulic motors are used for example to drive industrial machinery. A drive shaft of a machinery is installed inside the piston frame of the radial piston hydraulic motor and the torque and the rotational movement from the motor may be transferred to the machinery.

### OBJECTIVE OF THE INVENTION

The objective of the device is to alleviate the disadvantages mentioned above.

In particular, it is an objective of the present device to provide a more efficient radial piston hydraulic motor. This is achieved by providing a motor structure in which smaller bearings may be used and less forces are directed to the rotating shaft structure inside the motor. Therefore, the hydraulic fluid channels, which distribute the hydraulic fluid to the pistons, i.e. causes the motor rotate, have more space and less pressure and fluid speed reduction occurs, i.e. the motor is more efficient.

### SUMMARY

According to a first aspect, the present invention provides a radial piston hydraulic motor comprising a hollow rotating shaft inside the motor, which rotating shaft is arranged to rotate around its axial central axis A for providing torque from the radial piston hydraulic motor, wherein the rotating shaft comprises a piston frame with pistons, which are arranged to move radially, the piston frame comprises
a distribution surface, which is a flat surface in parallel plane with the radial movement of the pistons, and
a first inner surface extending in axial direction around the axial central axis A.

The rotating shaft comprises a half shaft having a second inner surface extending in axial direction around the axial central axis A, wherein piston frame and the half shaft are arranged adjacent to each other so that the first inner surface and the second inner surface form a surface, in axial direction, forming a cavity inside the rotating shaft for receiving a drive shaft.

In an embodiment, the radial piston hydraulic motor comprises a box frame with a cam ring connected thereto, which box frame comprises a distribution channel for hydraulic fluid, and a front end part and a rear end part so that the front end part is arranged at one side of the piston frame, in axial direction, and the rear end part is arranged on other side of the piston frame, in axial direction, and
pressure channels inside the piston frame to provide hydraulic fluid to each piston, which each pressure channel comprises a hydraulic fluid inlet at the distribution surface, which pressure channels are connectable with the distribution channel,
   wherein the pistons are engageable against an inner surface of the cam ring by means of the pressure of the hydraulic fluid.

In an embodiment, the first inner surface comprises first projections extending inwards into the cavity.

In an embodiment, the second inner surface comprises second projections extending inwards into the cavity.

In an embodiment, the motor comprises a cover plate for covering the cavity at the rear end part side of the motor, wherein the cover plate is fastened to the rear end part with fastening means.

In an embodiment, the motor comprises bearings and a shimming is provided between the cover plate and the rear end part for pre-loading the bearings.

In an embodiment, the motor comprises a brake arranged at the rear end part of the motor so that the brake is engageable with the drive shaft when the drive shaft is introduced inside the cavity, and the cover plate is configured to cover the brake.

In an embodiment, the front end part is connected to the piston frame via a first bearing.

In an embodiment, the first bearing is tapered roller bearing, which is tapered towards the front end of the motor, arranged to support axial force from the piston frame towards the front end.

In an embodiment, the rear end part is connected to the half shaft via bushing.

In an embodiment, the rear end part (32) is connected to the half shaft via a second bearing.

In an embodiment, the second bearing is tapered roller bearing, which is tapered towards the rear end of the motor, arranged to support axial force from the piston frame towards the rear end.

The first tapered roller bearing and the second roller bearing are tapered towards the ends of the motor, front end and rear end respectfully, i.e. the bearings are in X-montage.

In an embodiment, the half shaft comprises circumferential flange extending outwards.

In an embodiment, the circumferential flange is arranged to extend outwards of the half shaft into a space between the second bearing and the rear end part.

In an embodiment, the distribution surface is made by lapping.

It is to be understood that the aspects and embodiments of the invention described above may be used in any combination with each other. Several of the aspects and embodiments may be combined together to form a further embodiment of the invention.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 shows previously known radial piston hydraulic motor,

FIG. 2 shows a cross section of a radial piston hydraulic motor having a rotating shaft with separate piston frame and a half shaft, wherein a bushing is arranged at the rear end of the motor to allow rotation of the half shaft, and

FIG. 3 shows an embodiment of the radial piston hydraulic motor according to FIG. 2, wherein the bushing is replaced with a second bearing.

### DETAILED DESCRIPTION

In the description, the front end should be understood to be the end through which a drive shaft, for example from a machinery, is pushed inside the motor, and the back end is the other end of the motor.

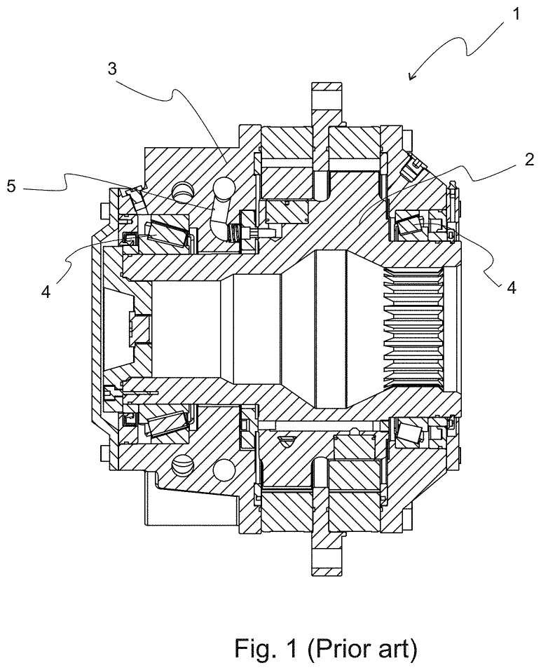

FIG. 1 shows one example of currently used radial piston hydraulic motors. The motor 1 comprises a rotating shaft structure 2 having monolithic structure, i.e. a piston frame and shaft are uniform structure. The shaft structure 2 is rotatably connected to the frame 3, i.e. the non-rotating part, of the motor at both ends via tapered roller bearings 4. In FIG. 1, the right end is the front end, through which the drive shaft is assembled inside the motor, and the left end is the rear end. The bearings are used as mechanical stops for the axial force from the non-rotating parts, which is caused by the pressure of the hydraulic fluid. To work as the mechanical stops, the bearings are tapered towards the center of the motor. With such bearing design, at least part of the axial forces is transferred from the frame to the shaft structure and, therefore, the wall thickness of the shaft structure must be big enough to support the forces. Further mechanical stop for the bearing is achieved by providing an end plate at the rear end of the motor. The end plate is fastened to the walls of the shaft structure by screws in axial direction. Thus, the wall thickness must be big enough to allow the screws to be fastened.

As the bearings must support significant forces from the frame, the size of the bearings 4 must be quite big. Therefore, the bearings 4, especially at the rear end, needs a lot of space. The hydraulic fluid is provided to the pistons through distribution channels 5 inside the frame. As the bearing needs significant amount of space, the space for distribution channels 5 is limited.

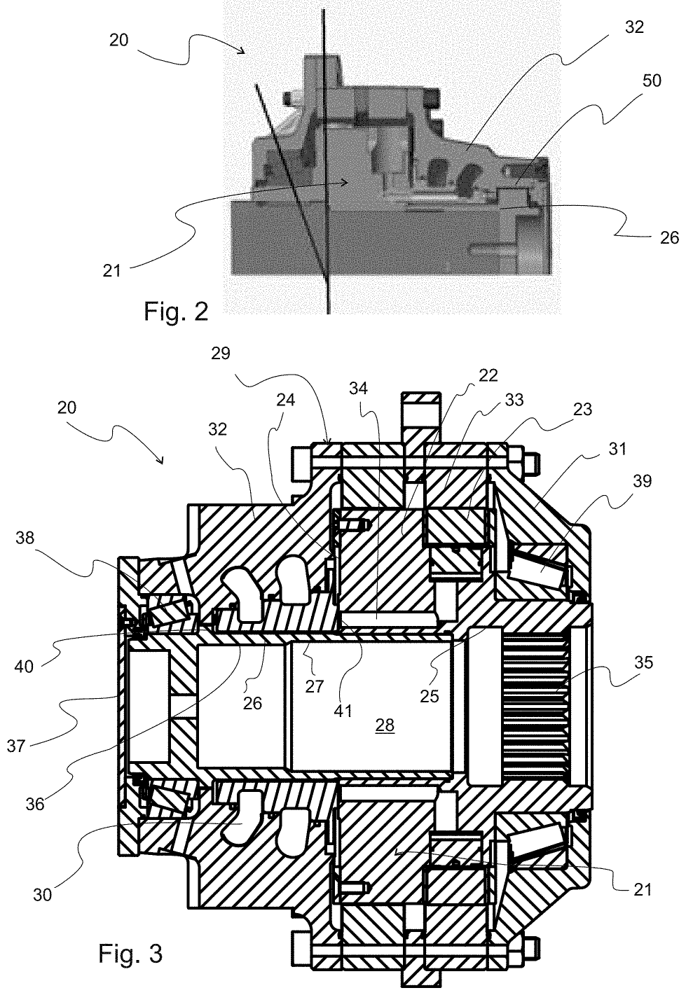

FIGS. 2 and 3 show a new design of radial piston hydraulic motor 20 having a hollow rotation shaft inside the motor 20. The rotation shaft 21 is arranged to rotate around its axial central axis A for providing torque from the radial piston hydraulic motor 20 to, for example, a drive shaft of a machinery, which may be installed inside the rotating shaft 21. In the new design, the monolithic rotating shaft 21 is replaced with a rotating shaft 21 with separate piston frame 22 and half shaft 26. Pistons 23 are provided inside the piston frame 22 and the pistons 23 are arranged to move radially. Further, the piston frame 22 comprises a distribution surface 24, which is a flat surface in parallel plane with the radial movement of the pistons 23, and a first inner surface 25, which is extending in axial direction around the axial central axis A. Further, the rotating shaft 21 comprises a half shaft 26 having a second inner surface 27, which is extending in axial direction around the axial central axis A. The piston frame 22 and the half shaft 26 are arranged adjacent to each other so that the first inner surface 25 and the second inner surface 27 form a surface, in axial direction, forming a cavity 28 inside the rotating shaft 21 for receiving the drive shaft from an application to which the rotation force is transferred, i.e. the surface formed by the first inner surface 25 and the second inner surface 27 are engageable with the drive shaft. The piston frame 22 and the half shaft 26 may be adjacent to each other so that they are partly overlapping, i.e. the half shaft 26 is partly inside the piston frame 22 as seen in some figures.

The radial piston hydraulic motor 20 may comprise a box frame 29 with a cam ring 33 connected thereto. The box frame 29 comprises a distribution channels 30, through which the hydraulic fluid is conducted to the pistons 23. The box frame 29 comprises a front end part 31 and a rear end part 32 so that the front end part 31 is arranged at one side of the piston frame 22, in axial direction, and the rear end part 32 is arranged on other side of the piston frame 22, in axial direction.

The radial piston hydraulic motor 20 may comprise pressure channels 34 inside the piston frame 22 to provide hydraulic fluid to each piston 23. Each pressure channel 34 comprises a hydraulic fluid inlet 41 at the distribution surface 24 and the pressure channels 34 are connectable with the distribution channel 30 via the hydraulic fluid inlet 41. The pistons 23 are engageable against an inner surface of the cam ring 33 by means of the pressure of the hydraulic fluid, such as hydraulic oil. The inner surface of the cam ring 33 is a waveshaped structure so that when the piston is pressed against the cam ring 33, the piston conforms the shape of the cam ring 33, which causes the piston frame 22, and the rotating shaft 21, to rotate.

The first inner surface 25 of the piston frame 22 may comprise first projections 35 extending inwards into the cavity 28. The first projections 35 are configured to be engaged with the drive shaft so that the rotation movement, and torque, is transferred from the rotating shaft 21 to the drive shaft.

The second inner surface 27 of the half shaft 26 may comprise second projections 36 extending inwards into the cavity 28. Said second projections 36 are configured to be engaged with the drive shaft.

In an embodiment, both, the first inner surface 25 and the second inner surface 27, comprise projections 35, 36 which are engageable with the drive shaft.

The projections or part of the projections may be splines.

The connection between the half shaft and the inner surface may be cylindrical and with or without projections towards the cavity.

The radial piston hydraulic motor 20 may comprise a cover plate 37 for covering the cavity 28 at the rear end part 32 side of the motor 20, wherein the cover plate 37 is fastened to the rear end part 32 with fastening means. The fastening means may be for example screws or bolts.

The rotation movement in relation to the static parts are achieved by providing bearings between the rotating parts and the static parts.

A shimming may be provided between the cover plate 37 and the rear end part 32 for pre-loading bearings.

The rear end part side of the motor may comprise a brake which is arranged between the cover plate and the rear end part so that it is engageable with the drive shaft when the drive shaft is installed inside the cavity. The brake may be for example an additional motor, encoder for direct speed and position measurement or any other braking device. With such arrangement, the brake may be mounted on the drive shaft directly without using the motor for transmitting the torque to the drive shaft.

The front end part 31 of the radial piston hydraulic motor 20 may be connected to the piston frame 22 via a first bearing 38, which allows the rotating shaft 21 structure to rotate around its axial central axis. The first bearing 38 may be a tapered roller bearing, which is tapered towards the front end of the motor 20, arranged to support axial force from the piston frame 22 towards the front end. The tapered roller bearing is a circumferential bearing arranged around the axial central axis of the rotating shaft 21, and between the piston frame 22 and the front end part 31. As the tapered roller bearing is tapered towards the front end of the motor 20, the axial force from the piston frame 22 is transferred through the tapered roller bearing towards the front end part 31.

The rear end part 32 may be connected to the half shaft 26 via bushing 50 (in FIG. 2), which allows the half shaft 26 part, and the rotating shaft 21, to rotate around its axial central axis. The bushing is a circumferential part around the axial central axis, and arranged between the half shaft 26 and the rear end part 32 allowing the half shaft to rotate in relation to the rear end part.

FIG. 3 shows has similar structure as in FIG. 2, except, instead of the bushing, the rear end part 32 is connected to the half shaft 26 via a second bearing 39, which allows the half shaft 26 to rotate around its axial central axis. Other parts of the motor 20 may be the same as in FIG. 2, which are capable to be implemented to the motor 20 of FIG. 2.

The second bearing 39 may tapered roller bearing, which is tapered towards the rear end of the motor 20, and arranged to support axial force from the piston frame 22 towards the rear end of the motor 20. The tapered roller bearing is a circumferential bearing arranged around the axial central axis of the rotating shaft 21, especially around the half shaft 26, and between the half shaft 26 and the front end part 31. The second bearing 39 may be arranged to support at least part of the axial force from the rear end part 32 of the motor 20, i.e. the second bearing 39 acts as a mechanical stop for the axial forces. The axial forces from the rotating shaft 21 and the rear end part 32 is transferred through the second bearing 39 into the cover plate 37, which is arranged to engage with the second bearing 39 and to act as a mechanical stop for the axial force through the second bearing 39. The cover plate 37 may also be arranged to act as a mechanical stop for the axial force from the non-rotating part, i.e. the rear end part 32 of the motor 20.

As the axial force from the rear end part 32 is not transferred through the bearing to the rotating shaft 21, as in known motors (e.g. in FIG. 1), the bearing needs to support less forces. Thus, the bearing may be much smaller and there is more space for the distribution channels and distribution fluids. Thus, it is possible to have more efficient motor without increasing the size of the motor.

The half shaft 26 may comprise a circumferential flange 40 extending outwards. The circumferential flange 40 may be arranged to extend outwards of the half shaft 26 into a space between the second bearing 39 and the rear end part 32, whereby the axial force from the half shaft 26 may be transferred to the second bearing 39 via the circumferential flange 40.

Because the rotating shaft 21 is made of two separate parts, i.e. the piston frame 22 and the half shaft 26, it allows more flexible and efficient manufacturing processes. For example, the distribution surface 24 may be made by lapping which results very smooth surface with reduced costs comparing for example to grinding.

By having the described structure, the motor may be more efficient without need to increase the size of the motor. The rotating shaft, i.e. the half shaft, does not need to be so rigid and smaller diameter and/or wall thickness is sufficient. Thus, the structure is more simpler and a drive shaft with greater diameter may be installed inside the cavity of the motor.

Although the invention has been the described in conjunction with a certain type of device, it should be understood that the invention is not limited to any certain type of device. While the present inventions have been described in connection with a number of exemplary embodiments, and implementations, the present inventions are not so limited, but rather cover various modifications, and equivalent arrangements, which fall within the purview of prospective claims.

1. A radial piston hydraulic motor comprising a hollow rotating shaft (inside the motor, which rotating shaft is arranged to rotate around its axial central axis A for providing torque from the radial piston hydraulic motor, wherein the rotating shaft comprises a piston frame with pistons, which are arranged to move radially, the piston frame comprises
a distribution surface, which is a flat surface in parallel plane with the radial movement of the pistons, and
a first inner surface extending in axial direction around the axial central axis A,
wherein the rotating shaft comprises a half shaft having a second inner surface extending in axial direction around the axial central axis A,
wherein piston frame and the half shaft are arranged adjacent to each other so that the first inner surface and the second inner surface form a surface, in axial direction, forming a cavity inside the rotating shaft for receiving a drive shaft.

2. The radial piston hydraulic motor according to claim 1, comprising
a box frame with a cam ring connected thereto, which box frame comprises a distribution channel for hydraulic fluid, and a front end part and a rear end part so that the front end part is arranged at one side of the piston frame, in axial direction, and the rear end part is arranged on other side of the piston frame, in axial direction, and
pressure channels inside the piston frame to provide hydraulic fluid to each piston, which each pressure channel comprises a hydraulic fluid inlet at the distribution surface, which pressure channels are connectable with the distribution channel,
wherein the pistons are engageable against an inner surface of the cam ring by means of the pressure of the hydraulic fluid.

3. The radial piston hydraulic motor according to claim 1, wherein the first inner surface comprises first projections extending inwards into the cavity.

4. The radial piston hydraulic motor according to claim 1, wherein the second inner surface comprises second projections extending inwards into the cavity.

5. The radial piston hydraulic motor according to claim 2, comprising a cover plate for covering the cavity at the rear end part side of the motor, wherein the cover plate is fastened to the rear end part with fastening means.

6. The radial piston hydraulic motor according to claim 5, wherein the motor comprises bearings and a shimming is provided between the cover plate and the rear end part for pre-loading the bearings.

7. The radial piston hydraulic motor according to claim 6, wherein the motor comprises a brake arranged at the rear end part of the motor so that the brake is engageable with the drive shaft when the drive shaft is introduced inside the cavity, and the cover plate is configured to cover the brake.

8. The radial piston hydraulic motor according to claim 2, wherein the front end part is connected to the piston frame via a first bearing.

9. The radial piston hydraulic motor according to claim 8, wherein the first bearing is tapered roller bearing, which is tapered towards the front end of the motor, arranged to support axial force from the piston frame towards the front end.

10. The radial piston hydraulic motor according to claim 2, wherein the rear end part is connected to the half shaft via bushing.

11. The radial piston hydraulic motor according to claim 2, wherein the rear end part is connected to the half shaft via a second bearing.

12. The radial piston hydraulic motor according to claim 1, wherein the second bearing is tapered roller bearing, which is tapered towards the rear end of the motor, arranged to support axial force from the piston frame towards the rear end.

13. The radial piston hydraulic motor according to claim 11, wherein the half shaft comprises circumferential flange extending outwards.

14. The radial piston hydraulic motor according to claim 13, wherein the circumferential flange is arranged to extend outwards of the half shaft into a space between the second bearing (and the rear end part.

15. The radial piston hydraulic motor according to claim 2, wherein the distribution surface is made by lapping.
